(19) United States
(12) Patent Application Publication
(10) Pub. No.: US 2026/0292254 A1
(43) Pub. Date: Sep. 24, 2026

(54) Methods and Apparatus for Selecting Transform Type in a Video Coding System

(71) Applicant: MEDIATEK INC., Hsinchu City (TW)

(72) Inventor: Shih-Ta HSIANG, Hsinchu City (TW)

(21) Appl. No.: 19/471,773

(22) PCT Filed: May 15, 2024
(86) PCT No.: PCT/CN2024/093284

§ 371 Date: Oct. 2, 2025

Related U.S. Application Data
(60) Provisional application No. 63/502,143, filed on May 15, 2023.

(51) Int. Cl. H04N 19/61; H04N 19/11; H04N 19/12; H04N 19/176

(52) U.S. Cl. CPC H04N 19/61; H04N 19/11; H04N 19/12; H04N 19/176

(57) ABSTRACT

A method and apparatus for video decoding for a MIP coded block are disclosed. According to one method, a MIP predictor for the current block is derived. Whether to set Planar mode or DC mode as the selected intra prediction mode is determined based on block dimension of the current block. A selected set of LFNST or NSPT is derived according to the selected intra prediction mode. Inverse transform is applied to the coded transformed residual data according to the selected set of LFNST or NSPT to derive reconstructed residual data. A reconstruct block is generated for the current block based on the reconstructed residual data and the MIP predictor. In another method, whether to set Planar mode or DC mode as the selected intra prediction mode is determined based on distribution of HoG.

### CROSS REFERENCE TO RELATED APPLICATIONS

The present invention is a non-Provisional Application of and claims priority to U.S. Provisional Patent Application No. 63/502,143, filed on May 15, 2023. The U.S. Provisional Patent Application is hereby incorporated by reference in its entirety.

### FIELD OF THE INVENTION

The present invention relates to video coding system. In particular, the present invention relates to determining a selected intra prediction mode, including Planar or DC mode, for deriving a set of LFNST or NSPT for a MIP coded block.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published Feb. 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In VVC, the Sequence Parameter Set (SPS) and the Picture Parameter Set (PPS) contain high-level syntax elements that apply to entire coded video sequences and pictures, respectively. The Picture Header (PH) and Slice Header (SH) contain high-level syntax elements that apply to a current coded picture and a current coded slice, respectively.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

In VVC, each CTU can be partitioned into one or multiple non-overlapped coding units (CUs) using a Quaternary Tree (QT) with nested Multi-Type-Tree (MTT) structure. The partitioning information is signalled by a coding tree syntax structure, where each CTU is treated as the root of a coding tree. The CTUs may be first partitioned by the quaternary tree (a.k.a. quadtree) structure, as shown in FIG. 2A. Then the quaternary tree leaf nodes can be further partitioned by a MTT structure, as shown in FIGS. 2B-E. There are four splitting types in multi-type tree structure: vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). Each quadtree child node may be further split into smaller coding tree nodes using any one of five split types in FIG. 2. However, each multi-type-tree child node is only allowed to be further split by one of four MTT split types. The coding tree leaf nodes correspond to the coding units (CUs). FIG. 3 provides an example of a CTU recursively partitioned by QT with the nested MTT, where the bold block edges represent quadtree partitioning and the remaining edges represent multi-type tree partitioning.

Each CU contains one or more Prediction Units (PUs). The prediction unit, together with the associated CU syntax, works as a basic unit for signalling the predictor information. The specified prediction process is employed to predict the values of the associated pixel samples inside the PU. Each CU may contain one or more transform units (TUs) for representing the prediction residual blocks. A transform unit (TU) is comprised of one transform block (TB) of luma samples and two corresponding transform blocks of chroma samples. Each TB corresponds to one residual block of samples from one colour component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one colour component associated with CTU, CU, PU, and TU, respectively. Thus, a CTU consists of one luma CTB, two chroma CTBs, and associated syntax elements. A similar relationship is valid for CU, PU, and TU.

### Matrix Weighted Intra Prediction (MIP)

Matrix weighted intra prediction (MIP) method is a newly added intra prediction technique in VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, i.e., averaging, matrix vector multiplication and linear interpolation as shown in FIG. 4. One line of H reconstructed neighbouring boundary samples 412 left of the block and one line of W reconstructed neighbouring boundary samples 410 above the block are shown as dot-filled small squares. After the averaging process, the boundary samples are down-sampled to top boundary line 414 and left boundary line 424. The down-sampled samples are provided to the matric-vector multiplication unit 420 to generate the down-sampled prediction block 430. An interpolation process is then applied to generate the prediction block 440.

### Low-Frequency Non-Separable Transform (LFNST)

In VVC, LFNST is applied between forward primary transform and quantization (at the encoder side) and between de-quantization and inverse primary transform (at the decoder side) as shown in FIG. 5. As shown in FIG. 5, after Forward Primary Transform 510, Forward Low-Frequency Non-Separable Transform LFNST 520 is applied to top-left region 522 of the Forward Primary Transform output, for example, 16 coefficients for 4×4 forward LFNST and/or 64 coefficients for 8×8 forward LFNST. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4). After LFNST, the transform coefficients are quantized by Quantization 530. To reconstruct the input signal, the quantized transform coefficients are de-quantized using De-Quantization 540 to obtain the de-quantized transform coefficients. Inverse LFNST 550 is applied to the top-left region 552 (8 coefficients for 4×4 inverse LFNST or 16 coefficients for 8×8 inverse LFNST). After invers LFNST, inverse Primary Transform 560 is applied to recover the input signal.

Joint Video Expert Team (JVET) of ITU-T SG16 WP3 and ISO/IEC JTC1 /SC29/WG11 are currently in the process of exploring the next-generation video coding standard. Some promising new coding tools have been adopted into Enhanced Compression Model 8 (ECM 8) (M. Coban, F. Le Léannec, R. -L. Liao, K. Naser, J. Ström, L. Zhang “Algorithm description of Enhanced Compression Model 8 (ECM 8),” Joint Video Expert Team (JVET) of ITU-T SG 16 WP 3 and ISO/IEC JTC 1/SC 29, Doc. JVET-AC2025, 29th Meeting, by teleconference, 11-20 January 2023) to further improve VVC.

In ECM-8, the number of LFNST sets(S) and candidates (C) are extended to S=35 and C=3. Three different kernels, LFNST4, LFNST8, and LFNST16, are defined to indicate LFNST kernel sets, which are applied to 4 ×N/N×4 (N≥4), 8 ×N/N×8 (N≥8), and M×N (M, N≥16), respectively. The separable DCT-II plus LFNST transform combinations can be replaced with non-separable primary transform (NSPT) for the block shapes ×4, 4×8, 8×4 and 8×8, 4×16, 16×4, 8×16 and 16×8. All NSPTs consist of 35 sets and 3 candidates (like the current LFNST in ECM- 8.0).

In ECM-8, for blocks using MIP or intra template matching prediction (intraTMP), decoder side intra mode derivation (DIMD) 610 is used to derive the intra prediction mode of the current block based on the MIP predicted samples as shown in FIG. 6. For MIP, this is done before upsampling. Specifically, a horizontal gradient and a vertical gradient are calculated for each predicted sample to build a histogram of gradient (HoG) 620 with 65 entries corresponding to the angular modes of VVC. Then the intra prediction mode with the largest histogram amplitude values is used to determine the LFNST transform set and LFNST transpose flag. In FIG. 6, matrix vector multiplication module 630 is used to generate MIP prediction 640; and further processed by MIP prediction upsampling module 650 to generate the upsampled output 660.

In the present invention, schemes for determining a selected intra prediction mode, including Planar or DC mode, for deriving a set of LFNST or NSPT for a MIP coded block are disclosed.

### BRIEF SUMMARY OF THE INVENTION

A method and apparatus for video decoding for a MIP coded block are disclosed. According to this method, input data including a current block is received, wherein the input data comprises coded transformed residual data associated with the current block, and wherein the current block is coded in MIP (Matrix weighted Intra Prediction) mode. A MIP predictor for the current block is derived. A selected intra prediction mode is determined, wherein said determining the selected intra prediction mode comprising determining whether to set Planar mode or DC mode as the selected intra prediction mode based on block dimension of the current block. A selected set of LFNST (Low-Frequency Non-Separable Transform) or NSPT (Non-Separable Primary Transform) is derived according to the selected intra prediction mode. Inverse transform is applied to the coded transformed residual data according to the selected set of LFNST or NSPT to derive reconstructed residual data. A reconstruct block is generated for the current block based on the reconstructed residual data and the MIP predictor.

In one embodiment, the block dimension of the current block comprises block width of the current block, block height of the current block, block area size of the current block, or a combination thereof. In one embodiment, when the block width of the current block, the block height of the current block, or both are greater than a threshold, the selected intra prediction mode is set to Planar mode. For example, the threshold comprises 8, 16, or 32. In one embodiment, when the block width of the current block, the block height of the current block, or both are not greater than a threshold, a DIMD (Decoder side Intra Mode Derivation) scheme or another non-block-dimension based scheme is used to determine the selected intra prediction mode. In one embodiment, HoG (Histogram of Gradient) with entries corresponding to angular intra prediction modes is derived for the current block based on MIP predictor samples, and the selected intra prediction mode is selected according to the HoG

According to another method, input data including a current block is received, wherein the input data comprises coded transformed residual data associated with the current block, and wherein the current block is coded in MIP (Matrix weighted Intra Prediction) mode. A MIP predictor for the current block is derived. A selected intra prediction mode is determined, wherein said determining the selected intra prediction mode comprising determining whether to set Planar mode or DC mode as the selected intra prediction mode based on distribution of HoG (Histogram of Gradient) with entries calculated for angular intra prediction modes based on MIP predictor samples of the current block. A selected set of LFNST (Low-Frequency Non-Separable Transform) or NSPT (Non-Separable Primary Transform) is derived according to the selected intra prediction mode. Inverse transform is applied to the coded transformed residual data according to the selected set of LFNST or NSPT to derive reconstructed residual data. A reconstruct block is generated for the current block based on the reconstructed residual data and the MIP predictor.

In one embodiment, the selected intra prediction mode is selected according to a ratio of a largest amplitude value of HoG to a sum of all HoG amplitude values. In another embodiment, the selected intra prediction mode is selected according to an average of all HoG amplitude values.

Corresponding methods for the encoder side are also disclosed.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2A-FIG. 2E illustrates examples of a multi-type tree structure corresponding to quadtree splitting (FIG. 2A) vertical binary splitting (SPLIT_BT_VER, FIG. 2B), horizontal binary splitting (SPLIT_BT_HOR, FIG. 2C), vertical ternary splitting (SPLIT_TT_VER, FIG. 2D), and horizontal ternary splitting (SPLIT_TT_HOR, FIG. 2E).

FIG. 3 shows an example of a CTU divided into multiple CUs with a quadtree and nested multi-type tree coding block structure, where the bold block edges represent quadtree partitioning and the remaining edges represent multi-type tree partitioning.

FIG. 4 illustrates an example of processing flow for Matrix weighted intra prediction (MIP).

FIG. 5 illustrates an example of Low-Frequency Non-Separable Transform (LFNST) process.

FIG. 6 illustrates an example of LFNST modification for MIP coded blocks, which utilizes DIMD to derive the LFNST transform set and determine LFNST transpose flag.

FIG. 7 illustrates a flowchart of an exemplary video coding system that determines whether to set Planar mode or DC mode as the selected intra prediction mode based on block dimension of the current block according to an embodiment of the present invention.

FIG. 8 illustrates a flowchart of an exemplary video coding system that determines whether to set Planar mode or DC mode as the selected intra prediction mode based on distribution of HoG with entries calculated for angular intra prediction modes based on MIP predictor samples of the current block according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In ECM-8.0, when a current block is coded in MIP, DIMD is adopted to determine the current intra prediction mode for deriving the selected transform set of LFNST or NSPT. However, DIMD can only be used to classify a block into one of 65 angular modes and cannot detect an intra prediction mode corresponding to DC or Planar mode. In the present invention, new methods are disclosed to improve the current scheme for determining the intra prediction mode, which is used for deriving the selected transform set of LFNST or NSPT for a current block coded in MIP mode in an image or video coding system. Particularly, methods are proposed to determine if the current prediction mode may belong to Planar or DC for deriving the selected transform set.

In one method, when a current block is coded in MIP mode, a video coder may determine whether to set the current intra prediction mode equal to one of Planar and DC for deriving the selected transform set of LFNST or NSPT considering the block dimension (width, height, and area size) of the current block. For example, when one or both of block width and height of a current block are greater than a specified threshold T_{wh}, a video coder may set the current intra prediction mode equal to Planar for deriving the selected transform set. Otherwise, the current intra prediction mode may be determined by DIMD or other specified methods. In some preferred embodiments, T_{wh} may be set equal to 8, 16, or 32.

In another method, when a current block is coded in MIP mode, a video coder may determine whether to set the current intra prediction mode equal to one of Planar and DC for deriving the selected transform set of LFNST or NSPT dependent on distribution of Histogram of Gradient (HoG) calculated by DIMD based on MIP samples. In some embodiments, when a current block is coded in MIP mode, a video coder may determine whether to set the current intra prediction mode equal to Planar or DC for deriving the selected transform set considering the ratio of the largest amplitude value of HoG to the sum of all HoG amplitude values. For example, when the ratio of the largest amplitude value of HoG to the sum of all HoG amplitude values is less than a specified threshold T1, a video coder may set the intra prediction mode of a current block equal to Planar for deriving the selected transform set. Otherwise, the current intra prediction mode may be set equal to the prediction mode selected by DIMD or other specified methods. In some preferred embodiments, T1 may be set equal to 0.0625, 0.125, 0.1875, 0.25, 0.375, or 0.5.

In some embodiments, when a current block is coded in MIP mode, a video coder may determine whether to set the current intra prediction mode equal to Planar or DC for deriving the selected transform set considering the average HoG amplitude values. For example, when the sum of HoG amplitude values is less than a specified threshold Ta scaled by the number of samples used for calculating the HoG, a video coder may set the intra prediction mode of a current block equal to Planar. Otherwise, the current intra prediction mode may be set equal to the prediction mode selected by DIMD or other specified methods.

In another method, when a current block is coded in MIP mode, a video coder may determine whether to set the current intra prediction mode equal to one of Planar and DC for deriving the selected transform set of LFNST or NSPT dependent on the prediction modes of neighbouring blocks. For example, a video coder may set the intra prediction mode of a current block equal to Planar or DC for deriving the selected transform set when both predefined above and left neighbouring blocks of the current block are predicted in Planar or DC mode or when all specified neighbouring blocks of the current block are predicted in Planar or DC mode.

The proposed methods may further comprise signalling one or more syntax elements in one or more high-level syntax sets to indicate the selected method in a current video data unit, wherein the high-level syntax sets may comprise SPS, PPS, PH, SH, or a combination thereof. The proposed methods may further comprise signalling one or more syntax elements to explicitly specify the threshold values used in the proposed methods.

The proposed methods and related embodiments can be implemented jointly in an image and video coding system. For example, when a current block is coded in MIP mode, a video coder may determine whether to set the current intra prediction mode equal to one of Planar and DC for deriving the selected transform set of LFNST or NSPT considering the block dimension of the current block and distribution of Histogram of Gradient (HoG) calculated by DIMD based on MIP samples jointly. In one example, when one or both of block width and height of a current block are greater than a specified threshold T_{wh} and the ratio of the largest amplitude value of HoG to the sum of all HoG amplitude values is less than a specified threshold T1, a video coder may set the intra prediction mode equal to Planar. Otherwise, the current intra prediction mode may be set equal to the prediction mode selected by DIMD or other specified methods.

In addition to MIP, the proposed methods can be similarly applied to other coding modes to determine the current intra prediction mode for deriving the selected transform set of LFNST, NSPT, or MTS such as the intraTMP mode, the cross-component linear model (CCLM) mode, the template-based intra mode derivation (TIMD) mode, the decoder side intra mode derivation (DIMD) mode, the inter mode, and the intra block copy (IBC) mode. The proposed methods can be utilized to determine whether to set the intra prediction mode equal to one of Planar and DC for deriving the selected transform set.

Any of the foregoing proposed methods for determining a selected intra prediction mode can be implemented in encoders and/or decoders. For example, any of the proposed methods can be implemented in an intra prediction module of an encoder, and/or an intra prediction module of a decoder. Alternatively, any of the proposed methods can be implemented as a circuit integrated to the intra prediction module of the encoder and/or the intra prediction module of the decoder. The proposed aspects, methods and related embodiments can be implemented individually or jointly in an image and video coding system.

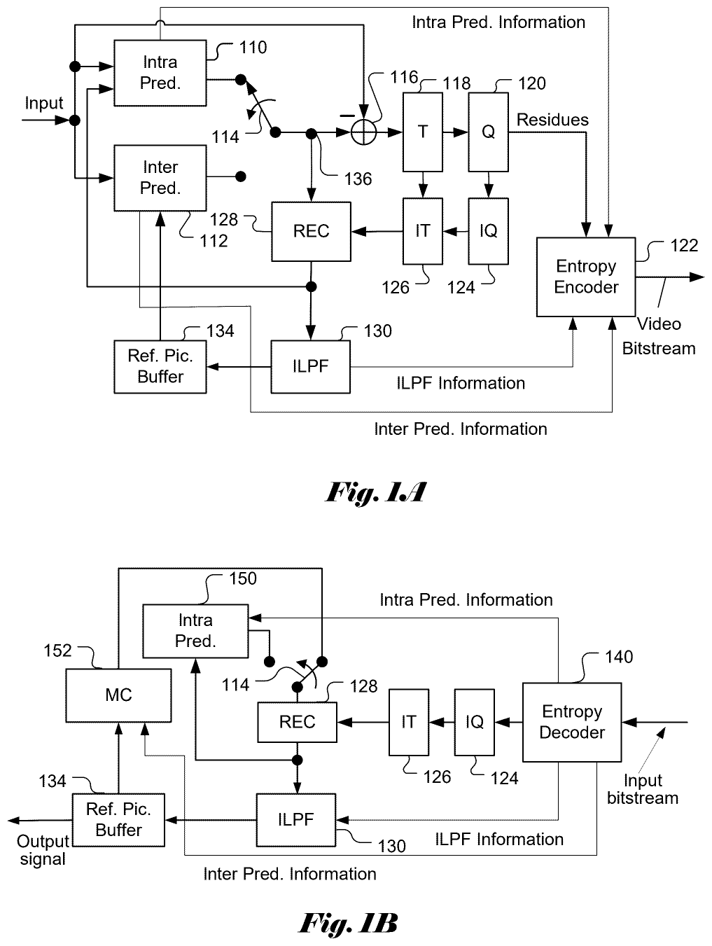

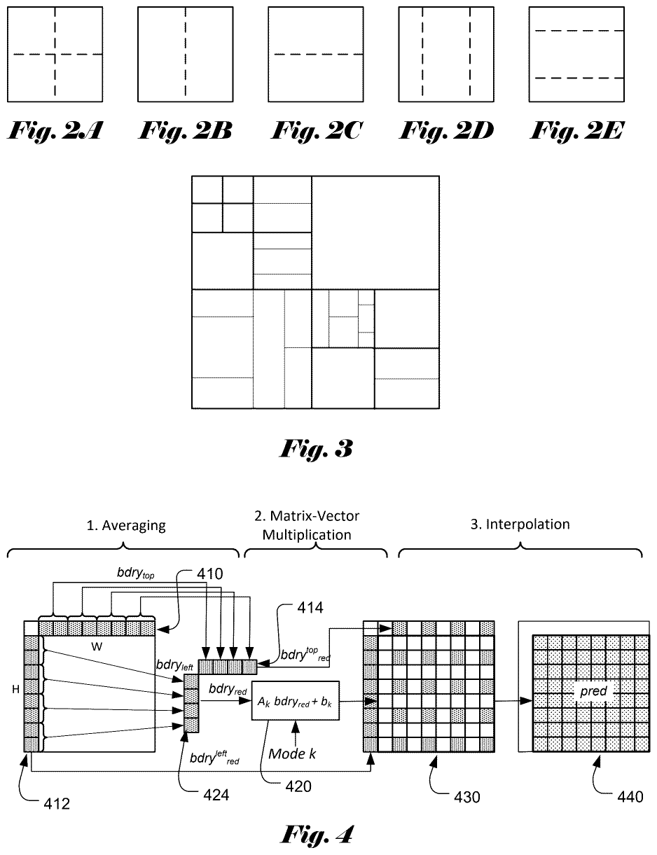

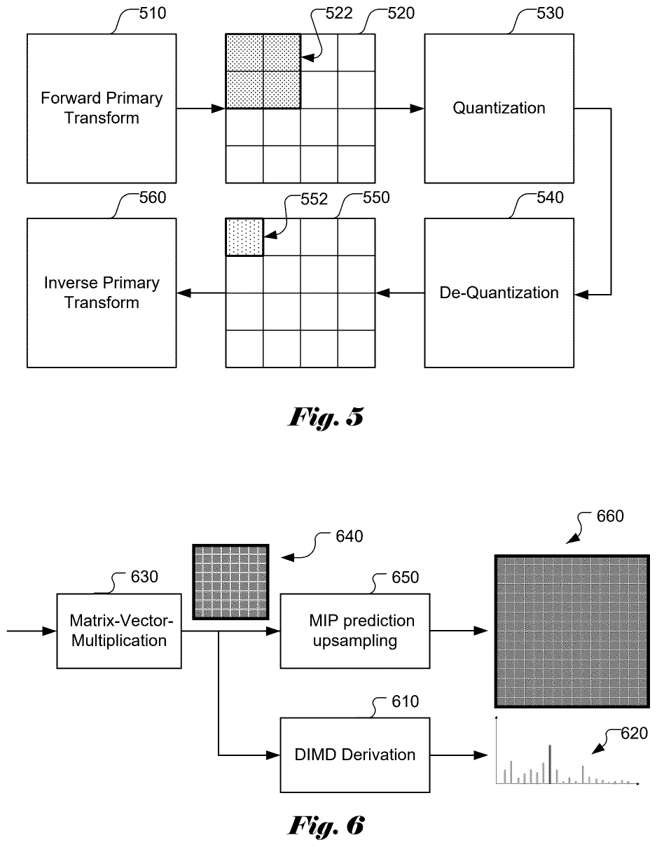

Any of the foregoing proposed methods for determining a selected intra prediction mode can be implemented as circuits coupled or integrated to the intra prediction module of the encoder and/or the intra prediction module of the decoder. The proposed aspects, methods and related embodiments can be implemented individually or jointly in an image and video coding system. For example, the proposed methods as described above can be implemented in an encoder side or a decoder side with reference to FIG. 1A and FIG. 1B. For example, any of the proposed methods can be implemented in an Intra coding module (e.g. Intra Pred. 150 in FIG. 1B) in a decoder or an Intra coding module in an encoder (e.g. Intra Pred. 110 in FIG. 1A). Any of the proposed candidate derivation method can also be implemented as circuits coupled to the intra coding module at the decoder or the encoder. However, the decoder or encoder may also use additional processing unit to implement the required processing. While the Intra Pred. units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

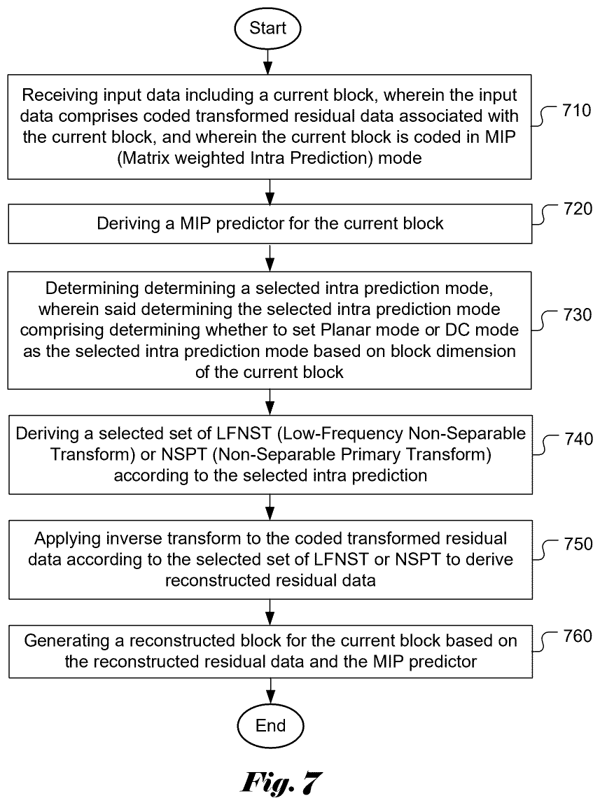

FIG. 7 illustrates a flowchart of an exemplary video coding system that determines whether to set Planar mode or DC mode as the selected intra prediction mode based on block dimension of the current block according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data including a current block is received in step 710, wherein the input data comprises coded transformed residual data associated with the current block, and wherein the current block is coded in MIP (Matrix weighted Intra Prediction) mode. A MIP predictor for the current block is derived in step 720. A selected intra prediction mode is determined in step 730, wherein said determining the selected intra prediction mode comprising determining whether to set Planar mode or DC mode as the selected intra prediction mode based on block dimension of the current block. A selected set of LFNST (Low-Frequency Non-Separable Transform) or NSPT (Non-Separable Primary Transform) is derived according to the selected intra prediction mode in step 740. Inverse transform is applied to the coded transformed residual data according to the selected set of LFNST or NSPT to derive reconstructed residual data in step 750. A reconstructed block is generated for the current block based on the reconstructed residual data and the MIP predictor in step 760.

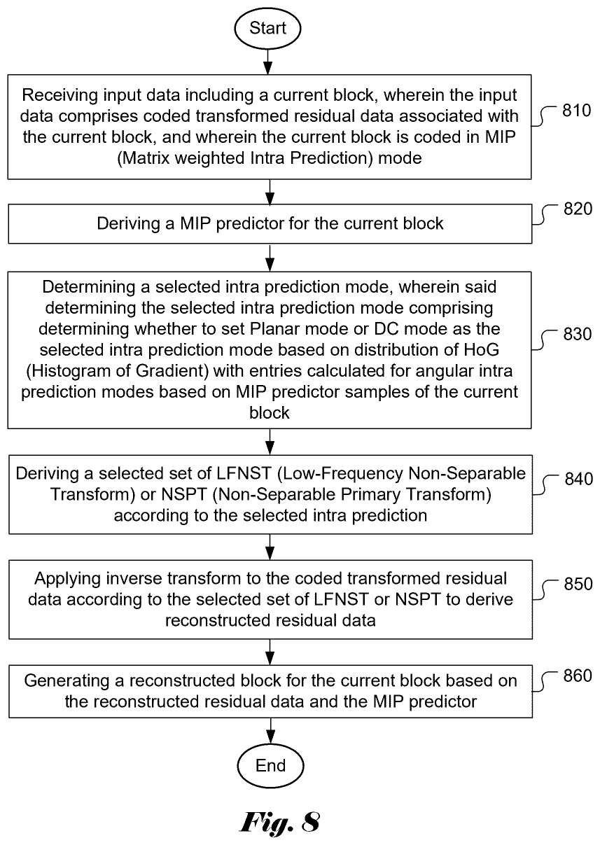

FIG. 8 illustrates a flowchart of an exemplary video coding system that determines whether to set Planar mode or DC mode as the selected intra prediction mode based on distribution of HoG with entries calculated for angular intra prediction modes based on MIP predictor samples of the current block according to an embodiment of the present invention. According to this method, input data including a current block is received in step 810, wherein the input data comprises coded transformed residual data associated with the current block, and wherein the current block is coded in MIP (Matrix weighted Intra Prediction) mode. A MIP predictor for the current block is derived in step 820. A selected intra prediction mode is determined in step 830, wherein said determining the selected intra prediction mode comprising determining whether to set Planar mode or DC mode as the selected intra prediction mode based on distribution of HoG (Histogram of Gradient) with entries calculated for angular intra prediction modes based on MIP predictor samples of the current block. A selected set of LFNST (Low-Frequency Non-Separable Transform) or NSPT (Non-Separable Primary Transform) is derived according to the selected intra prediction mode in step 840. Inverse transform is applied to the coded transformed residual data according to the selected set of LFNST or NSPT to derive reconstructed residual data in step 850. A reconstructed block is generated for the current block based on the reconstructed residual data and the MIP predictor in step 860.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving input data including a current block, wherein the input data comprises coded transformed residual data associated with the current block, and wherein the current block is coded in MIP (Matrix weighted Intra Prediction) mode;
deriving a MIP predictor for the current block;
determining a selected intra prediction mode, wherein said determining the selected intra prediction mode comprising determining whether to set Planar mode or DC mode as the selected intra prediction mode based on block dimension of the current block;
deriving a selected set of LFNST (Low-Frequency Non-Separable Transform) or NSPT (Non-Separable Primary Transform) according to the selected intra prediction mode;
applying inverse transform to the coded transformed residual data according to the selected set of LFNST or NSPT to derive reconstructed residual data; and
generating a reconstructed block for the current block based on the reconstructed residual data and the MIP predictor.

2. The method of claim 1, wherein the block dimension of the current block comprises block width of the current block, block height of the current block, block area size of the current block, or a combination thereof.

3. The method of claim 2, wherein when the block width of the current block, the block height of the current block, or both are greater than a threshold, the selected intra prediction mode is set to Planar mode.

4. The method of claim 3, wherein the threshold comprises 8, 16, or 32.

5. The method of claim 3, wherein when the block width of the current block, the block height of the current block, or both are not greater than a threshold, a DIMD (Decoder side Intra Mode Derivation) scheme or another non-block-dimension based scheme is used to determine the selected intra prediction mode.

6. The method of claim 5, wherein HoG (Histogram of Gradient) with entries corresponding to angular intra prediction modes is derived for the current block based on MIP predictor samples, and the selected intra prediction mode is selected according to the HoG.

7. An apparatus of video decoding, the apparatus comprising one or more electronics or processors arranged to:
receive input data including a current block, wherein the input data comprises coded transformed residual data associated with the current block, and wherein the current block is coded in MIP (Matrix weighted Intra Prediction) mode;
derive a MIP predictor for the current block;
determine a selected intra prediction mode, wherein a process to determine the selected intra prediction mode comprising determining whether to set Planar mode or DC mode as the selected intra prediction mode based on block dimension of the current block;
derive a selected set of LFNST (Low-Frequency Non-Separable Transform) or NSPT (Non-Separable Primary Transform) according to the selected intra prediction mode;
apply inverse transform to the coded transformed residual data according to the selected set of LFNST or NSPT to derive reconstructed residual data; and
generate a reconstructed block for the current block based on the reconstructed residual data and the MIP predictor.

8. A method of video encoding, the method comprising:
receiving input data including a current block, wherein the input data comprises pixel data to be coded, and wherein the current block is coded in MIP (Matrix weighted Intra Prediction) mode;
deriving a MIP predictor for the current block;
determining a selected intra prediction mode, wherein said determining the selected intra prediction mode comprising determining whether to set Planar mode or DC mode as the selected intra prediction mode based on block dimension of the current block;
deriving a selected set of LFNST (Low-Frequency Non-Separable Transform) or NSPT (Non-Separable Primary Transform) according to the selected intra prediction mode; and
applying transform to residual data according to the selected set of LFNST or NSPT, wherein the residual data is generated based on the current block and the MIP predictor.

9. An apparatus of video encoding, the apparatus comprising one or more electronics or processors arranged to:
receive input data including a current block, wherein the input data comprises pixel data to be coded, and wherein the current block is coded in MIP (Matrix weighted Intra Prediction) mode;
derive a MIP predictor for the current block;
determine a selected intra prediction mode, wherein a process to determine the selected intra prediction mode comprising determining whether to set Planar mode or DC mode as the selected intra prediction mode based on block dimension of the current block;
derive a selected set of LFNST (Low-Frequency Non-Separable Transform) or NSPT (Non-Separable Primary Transform) according to the selected intra prediction mode; and
apply transform to residual data according to the selected set of LFNST or NSPT, wherein the residual data is generated based on the current block and the MIP predictor.

10. A method of video decoding, the method comprising:
receiving input data including a current block, wherein the input data comprises coded transformed residual data associated with the current block, and wherein the current block is coded in MIP (Matrix weighted Intra Prediction) mode;
deriving a MIP predictor for the current block;
determining a selected intra prediction mode, wherein said determining the selected intra prediction mode comprising determining whether to set Planar mode or DC mode as the selected intra prediction mode based on distribution of HoG (Histogram of Gradient) with entries calculated for angular intra prediction modes based on MIP predictor samples of the current block;
deriving a selected set of LFNST (Low-Frequency Non-Separable Transform) or NSPT (Non-Separable Primary Transform) according to the selected intra prediction mode;
applying inverse transform to the coded transformed residual data according to the selected set of LFNST or NSPT to derive reconstructed residual data; and
generating a reconstructed block for the current block based on the reconstructed residual data and the MIP predictor.

11. The method of claim 10, wherein the selected intra prediction mode is selected according to a ratio of a largest amplitude value of HoG to a sum of all HoG amplitude values.

12. The method of claim 10, wherein the selected intra prediction mode is selected according to an average of all HoG amplitude values.

13. An apparatus of video decoding, the apparatus comprising one or more electronics or processors arranged to:
receive input data including a current block, wherein the input data comprises coded transformed residual data associated with the current block, and wherein the current block is coded in MIP (Matrix weighted Intra Prediction) mode;
derive a MIP predictor for the current block;
determine a selected intra prediction mode, wherein a process to determine the selected intra prediction mode comprising determining whether to set Planar mode or DC mode as the selected intra prediction mode based on distribution of HoG (Histogram of Gradient) with entries calculated for angular intra prediction modes based on MIP predictor samples of the current block;
derive a selected set of LFNST (Low-Frequency Non-Separable Transform) or NSPT (Non-Separable Primary Transform) according to the selected intra prediction mode;
apply inverse transform to the coded transformed residual data according to the selected set of LFNST or NSPT to derive reconstructed residual data; and
generate a reconstructed block for the current block based on the reconstructed residual data and the MIP predictor.

14. A method of video encoding, the method comprising:
receiving input data including a current block, wherein the input data comprises pixel data to be coded, and wherein the current block is coded in MIP (Matrix weighted Intra Prediction) mode;
deriving a MIP predictor for the current block;
determining a selected intra prediction mode, wherein said determining the selected intra prediction mode comprising determining whether to set Planar mode or DC mode as the selected intra prediction mode based on distribution of HoG (Histogram of Gradient) with entries calculated for angular intra prediction modes based on MIP predictor samples of the current block;
deriving a selected set of LFNST (Low-Frequency Non-Separable Transform) or NSPT (Non-Separable Primary Transform) according to the selected intra prediction mode; and
applying transform to residual data according to the selected set of LFNST or NSPT, wherein the residual data is generated based on the current block and the MIP predictor.

15. An apparatus of video encoding, the apparatus comprising one or more electronics or processors arranged to:
receive input data including a current block, wherein the input data comprises pixel data to be coded, and wherein the current block is coded in MIP (Matrix weighted Intra Prediction) mode;
derive a MIP predictor for the current block;
determine a selected intra prediction mode, wherein a process to determine the selected intra prediction mode comprising determining whether to set Planar mode or DC mode as the selected intra prediction mode based on distribution of HoG (Histogram of Gradient) with entries calculated for angular intra prediction modes based on MIP predictor samples of the current block;
derive a selected set of LFNST (Low-Frequency Non-Separable Transform) or NSPT (Non-Separable Primary Transform) according to the selected intra prediction mode; and
apply transform to residual data according to the selected set of LFNST or NSPT, wherein the residual data is generated based on the current block and the MIP predictor.
